(19) United States
(12) Patent Application Publication
(10) Pub. No.: US 2006/0285960 A1
(43) Pub. Date: Dec. 21, 2006

(54) Forklift attachment

(76) Inventor: Jeff Scott Hitchcock, Winterhaven, FL (US)

Correspondence Address: Alan M. Weisberg;Christopher & Weisberg, P.A., Suite 2040, 200 East Las Olas Boulevard, Fort Lauderdale, FL, 33301, US

(21) Appl. No.: 11/148,464

(22) Filed: Jun. 9, 2005

(51) Int. Cl. B66F 9/12

(52) U.S. Cl. 414/664

(57) ABSTRACT

An apparatus for attachment to a forklift. The apparatus includes laterally pivotable support members that can support objects of varying widths. The forklift attachment is releasably attached to the front end of a fork lift over the horizontal members or “forks” in order to expand or extend the carrying capacity of the “forks”. The forklift attachment includes a main horizontal member to which are centrally attached a pair of vertical members. A plurality of inner, fixed support members are perpendicularly attached to the main horizontal member at the medial portion thereof and outer, pivoting support members are hingedly attached to each end of the main horizontal support member.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to an apparatus for attachment to a forklift and more specifically to an apparatus that affixes to a forklift and includes laterally pivotable support members that can support objects of varying widths.

### BACKGROUND OF THE INVENTION

This version of the invention is concerned with the field of accessories or attachments for forklifts and forklift-type vehicles. More specifically, this version of the invention is concerned with an attachment that is releasably attached to the fork or lifting portion of a forklift in order to expand or extend the carrying capacity of said fork or lifting portion of a forklift or forklift-type vehicle.

Forklifts are used to lift, transport, and deposit items that are typically too bulky or heavy to be carried by one or more persons from a first location to a second location within a warehouse, storage facility, retail center, etc. A conventional forklift is a motorized vehicle fitted on its front end with a lift apparatus, which is partially constructed of horizontal lifting members or “forks” that are positioned under and against an item to be moved. As the “forks” are raised, they elevate the item at some distance above the floor or ground surface at which time the forklift is driven to a second location where the item is deposited either on the floor or ground surface or onto a shelf, a raised storage location, or the like.

However, the lifting capacity of the forklift is limited by the shape of and the perimeter formed by the horizontal members or “forks.” In fact, many items are loaded onto pallets or similar devices for transport by a forklift. The pallets are designed to receive and accommodate the specific dimensions and shape of the horizontal members or “forks.” When certain items are irregular in shape or exceed the perimeter formed by the horizontal members or “forks,” the forklift is unable to transport such items. For instance, prefabricated roof trusses, which can span sixty feet in width, are unable to be lifted and transported by a forklift. In some situations, it is necessary to employ more than one forklift to transport a roof truss, a diversion of manpower and equipment that is inefficient and possibly hazardous.

What is needed then to overcome the referenced limitations of forklifts is the provision of a fork lift attachment that can be releasably attached to the horizontal members or “forks” in order to expand or extend the carrying capacity of said horizontal members or “forks.” Such an attachment would be adjustable to accommodate and transport roof trusses or other items of varying shape, size, and configuration.

Numerous designs for accessories that expand the carrying capacity of forklifts have been provided in the prior art. Even though these designs may be suitable for the specific individual purposes to which they address, they would not be suitable for the purposes of the present version of the invention as they are relatively elaborate in design and construction and are cumbersome to install and operate. These designs are exemplified by U.S. Pat. No. 4,708,576, entitled “Accessory For Expanding The Payload Capacity Of A Forklift”, issued to Conley on Nov. 24, 1987, and U.S. Pat. No. 5,128,247, entitled “Wide Load Rack For Forklift”, issued to Royden on Jun. 2, 1992.

As such, it may be appreciated that there is a continuing need for a new and improved forklift attachment that is simplified in design and construction, employs a minimum number of components, and incorporates adjustment features in order to accommodate and transport roof trusses and other items of varying size, shape, and configuration. In these respects, the present version of the invention substantially departs from the conventional concepts and designs of the prior art, and in so doing provides an apparatus that substantially fulfills this need. Additionally, the prior patents and commercial techniques do not suggest the present inventive combination of component elements arranged and configured as disclosed herein.

The present invention achieves its intended purposes, objects, and advantages through a new, useful and unobvious combination of method steps and component elements, with the use of a minimum number of functioning parts, at a reasonable cost to manufacture, and by employing only readily available materials.

### SUMMARY OF THE INVENTION

The present version of the invention, which will be described in greater detail hereinafter, relates to the field of accessories or attachments for forklifts and forklift-type vechicles. More specifically, this version of the invention is concerned with an attachment that is releasably attached to the fork or lifting portion of a forklift in order to expand or extend the carrying capacity of said fork or lifting portion of a forklift or forklift-type vehicle. My version of the invention overcomes all of the shortcomings listed previously, in addition to novel aspects that will be described in detail hereinafter.

Described briefly, according to a typical embodiment, the invention presents a forklift attachment that is releasably attached to the front end of a fork lift over the horizontal members or “forks” in order to expand or extend the carrying capacity of said “forks”. The forklift attachment is constructed of a main horizontal member to which are centrally attached in perpendicular arrangement a pair of vertical members. A pair of fixed support members are perpendicularly attached to the main horizontal member at the medial portion thereof, and pivoting support members are hingedly attached to each end of said main horizontal support member. The fixed support members are constructed to form a channel on the underside thereof. A bracket with a pin disposed therein extends for some distance from the rear end of each fixed support member. The components of the forklift attachment are constructed of material that is relatively lightweight and durable, such as various metals (carbon, steel, aluminum) or composite materials.

During use, the forklift attachment is secured to the lift chassis of a forklift by positioning the fixed support members over the “forks,” ensuring that said “forks” are received by the channels of the fixed support members. The space enclosed by the brackets receives the vertical members of the lift chassis attached to the forks. The brackets are secured to the vertical members by the pins. As needed, the pivoting support members are rotated to accommodate and support particular roof trusses and other items to be lifted and transported from a first location and deposited to a second location.

My invention, therefore, resides not in any one of these features per se, but rather in the particular combination of all of them herein disclosed. It is distinguished from the prior art in this particular combination of all of its structures for the functions specified.

In order that the detailed description of the invention may be better understood and that the present contribution to the art can be more fully appreciated, additional features of the invention will be described hereinafter. It should be appreciated by those skilled in the art that the conception and the disclosed specific methods and structures may be readily utilized as a basis for modifying or designing other structures for carrying out the same purposes of the present invention. It should be realized by those skilled in the art that such equivalent methods and structures do not depart from the spirit and scope of the invention.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application nor is it intended to be limiting as to the scope of the invention in any way.

In an embodiment of the present invention, a forklift attachment is provided. The attachment includes a horizontal member having hinges on the remote ends thereof. The attachment also includes a plurality of pivotable outer support members in rotational engagement with the hinges and extending laterally therefrom wherein the pivotable outer support members can be pivoted laterally to support objects of varying sizes and dimensions. Finally, one or more fixed support members mounted on the horizontal member and extending laterally therefrom is provided. The one or more fixed support members are adapted to fit over fork members of a forklift and support an object thereon.

In another embodiment, a forklift attachment for a forklift, which is capable of transporting roof trusses is provided. The forklift attachment includes a horizontal beam member having hinges with vertical hinge pins on the remote ends thereof, outer support members pivotably coupled to the hinges wherein the outer support members can be pivoted horizontally to support roof trusses of varying widths and dimensions, two or more vertical members mounted on the horizontal beam, and a pair of fixed, substantially horizontal support members mounted on the horizontal beam. The fixed horizontal support members are adapted to fit over the fork members of forklift.

Accordingly, it is an object of my version of the invention to provide a low-cost, easy-to-manufacture, and easy-to-market moving attachment for a forklift.

Another object of the invention is to provide a moving attachment for a forklift that is constructed in-part of pivoting support members that can accommodate and support roof trusses and other items of varying size, shape, and configuration.

A final object of the invention is to provide a moving attachment for a forklift that employs a simplified design incorporating a minimum number of components in order to allow efficient use with a variety of forklifts and other similarly constructed lifting devices.

For a better understanding of the invention, its operating advantages and the specific objects attained by its uses, reference should be made to the accompanying drawings and descriptive matter in which there is illustrated a preferred embodiment of the invention. The foregoing has outlined some of the more pertinent objects of the invention. These objects should be construed to be merely illustrative of some of the more prominent features and applications of the present invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiment in addition to the scope of the invention illustrated by the accompanying drawings.

### DESCRIPTION OF THE DRAWINGS

The foregoing and other objects, features and advantages of the invention will become more fully understood from the following description of the preferred embodiment of the invention as illustrated in the accompanying drawings in which like reference characters refer to the same parts throughout different views. The drawings are not necessarily to scale, emphasis instead being placed upon illustrating the principles of the invention.

FIG. 1 is a perspective view of a forklift attachment in accordance with the present version of the invention;

FIG. 2 is a front elevation view of a forklift attachment in accordance with the present version of the invention;

FIG. 3 is a top plan view of a forklift attachment according to line 1-1 of FIG. 2;

FIG. 4 is a side elevation view of a forklift attachment according to line 2-2 of FIG. 2;

FIG. 5 is a perspective view of a conventional forklift;

FIG. 6 is a perspective view of a conventional forklift with the forklift attachment releasably attached thereon;

FIG. 7 is a perspective view of a conventional forklift with the forklift attachment releasably attached thereon supporting a roof truss for transport;

FIG. 8 is a front view of an alternate embodiment of the forklift attachment in accordance with the present version of the invention;

FIG. 9 is a top view of the stop member that limits the outer pivoting support members from swinging past a predetermined position; and

FIG. 10 is a perspective view of a conventional forklift with the alternate embodiment of the forklift attachment releasably attached thereon.

A more complete understanding of the present invention, and the attendant advantages and features thereof, will be more readily understood by reference to the following detailed description when considered in conjunction with the accompanying drawings.

### DETAILED DESCRIPTION OF THE INVENTION

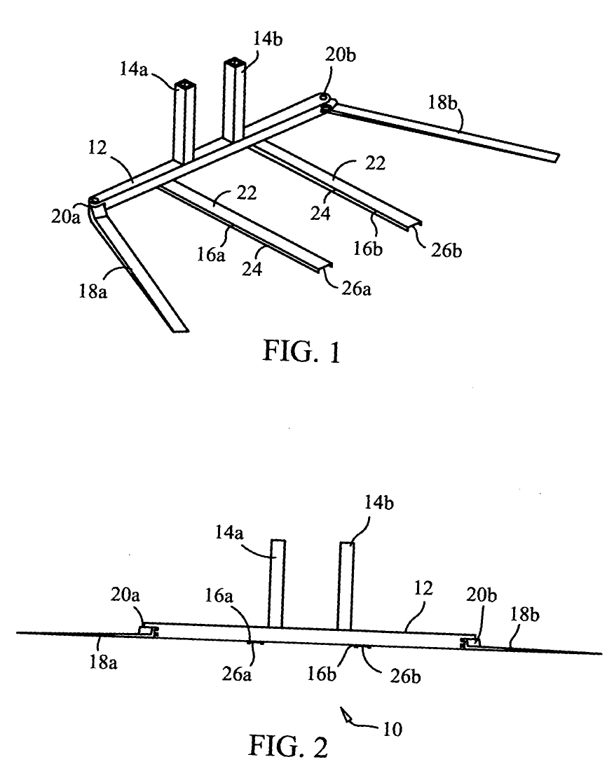

Referring now to the drawings and, in particular, to FIG. 1 through FIG. 4 wherein there are illustrated a typical embodiment of the moving attachment for forklift 10. The present version of the invention 10 is intended to be used with a variety of forklifts and other lifting devices employing horizontal lifting members or “forks” in order to expend or extend the carrying capacity thereof for lifting, transporting, and depositing root trusses or other items that exceed the carrying capacity of conventional forklifts. The forklift attachment 10 is constructed of an elongated, rectangular main horizontal member 12 and two elongated, rectangular vertical members 14a and 14b, which are disposed in a substantially parallel relation and attached in a substantially perpendicular arrangement to the medial portion of the horizontal member 12.

A pair of elongated, rectangular fixed inner support members 16a and 16b, disposed in parallel relation, are secured perpendicularly to the medial portion of the horizontal member 12, and a pair of elongated, rectangular pivoting outer support members 18a and 18b, are attached in rotating engagement to the distal ends of the main horizontal member 12 by means of hinges 20a and 20b. Preferably, the pivoting support members 18a and 18b, taper downward from the end attached to the hinges 20a and 20b to the distal end thereof. In an alternate embodiment, the fixed support members 16a and 16b are also tapered with the thickest part proximate the horizontal member. The present invention is not limited in the number of inner, fixed support members or outer, pivoting support members and may incorporate any number of each.

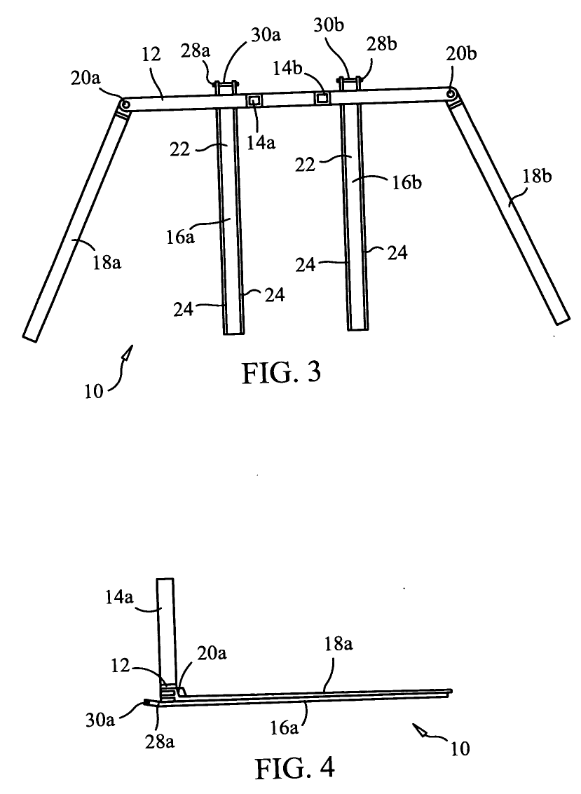

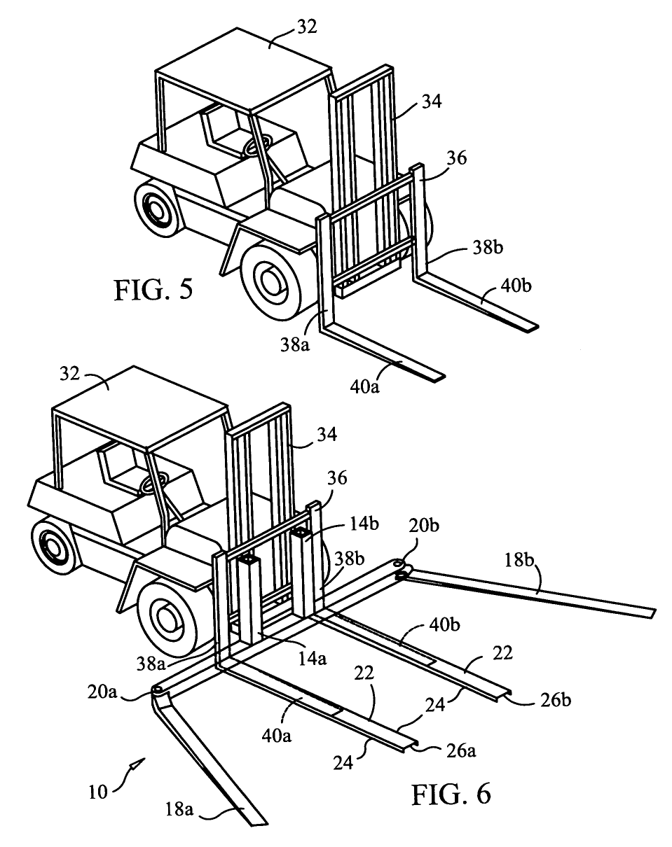

The fixed support members 16a and 16b are constructed of a flat, rectangular top side member 22 and two narrow, rectangular lateral side members 24, which are disposed parallel to each other and attached to the top side member in perpendicular arrangement. As such, the top side member 22 and lateral side members 24 of each support netter 16a and 16b form a channel 26a and 26b on the underside thereof that receives a corresponding horizontal lifting member or “fork” of a forklift. As shown most clearly in FIGS. 3 and 4, bracket members 28a and 28b are attached to or extend from the rear side of each fixed support member 16a and 16b. Cylindrical retaining pins 30a, and 30b are disposed within each bracket member 28a and 28b proximate to the unattached end thereof. The components are manufactured of material that is lightweight, durable, and economical to acquire and/or fabricate, such as various metals (aluminum, carbon and steel) and composite materials.

Referring to FIG. 5, therein illustrated is a conventional forklift 32 constructed with a lift chassis 34 and lift member 36 secured to the front end thereof. The lift member 36 is further comprised of a pair of vertical members 38a and 3 8b, and a pair of horizontal members 40a and 40b or “forks,” which are joined in perpendicular configuration.

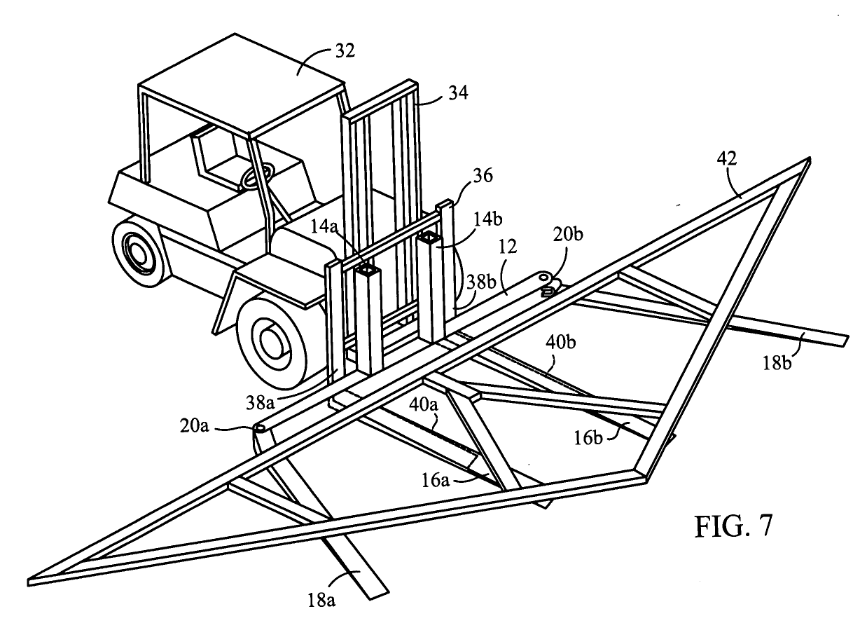

In FIG. 6, the forklift attachment 10 is fitted onto the forklift 32 with the fixed support members 16a and 16b positioned over the horizontal members 40a and 40b so that the channels 26a and 26b of the fixed support members 16a and 16b receive said horizontal members 40a and 40b in abutting engagement. The space enclosed by the bracket members 28a and 28b (not shown) receives the vertical members 38a and 38b, and the retaining pins 30a and 30b (not shown) to prevent the bracket members 28a and 28b from becoming separated from the vertical members 38a and 38b once the bracket members 28a and 28b are fitted around said vertical members 38a and 38b.

The vertical members 14a and 14b of the attachment 10 are secured in abutting arrangement against the lift member 36 adjacent to the vertical members 38a and 38b thereof. In an exemplary embodiment, a roof truss 42, displayed in FIG. 7, is positioned sideways onto the forklift attachment 10 with the fixed support members 16a and 16b and pivoting support members 18a and 18b making contact with the truss 42 and providing adequate support for lifting and transporting truss 42 from a first location for placement to a second location. As necessary, several roof trusses 42 may be placed onto the forklift attachment 10 up to the carrying capacity of said attachment 10. In order to accommodate roof trusses 42 of varying shape, size, and configuration, the pivoting support members 18a and 18b can be rotated as required to provide proper support and stability.

To operate the pivotable support members 18a and 18b, the forklift operator positions the forklift 32 such that forklift members 40a and 40b slide underneath channels 26a and 26b of fixed support members 16a and 16b respectively. Once the forklift 32 is secured to attachment 10 in this fashion, the forklift operator can manipulate outer pivoting support members 18a and 18b to accommodate the object to be lifted. In order to accommodate an object with a large width such as the roof truss depicted in FIG. 7, the operator may use several options to position the outer support members 18a and 18b.

In one embodiment, the operator can manipulate attachment 10 such that outer support members 18a and 18b swing laterally outward by the force of gravity in conjunction with hinges 20a and 20b. After a short practice period, a forklift operator can become proficient at manipulating attachment 10 in order to swing one and then the other support member (or both at the same time) until a proper attachment span has been attained. Because outer pivoting members 18a and 18b are sloped slightly downward, a slight horizontal shifting by the forklift operator of apparatus 10 results in the lateral pivoting of each outer member 18a and 18b.

After proper manipulation, the forklift 32 can now be driven forward until the object is supported by all of the support members. In an alternate embodiment, the forklift operator can control outer support members 18a and 18b via commonly used methods such as electronic, pneumatic, hydraulic or manual controls.

The present invention is not limited to the number or the dimension of fixed support members 16a and 16b or pivoting outer support members 18a and 18b. For example, two or more fixed support members may extend laterally from horizontal member 12. Additional fixed support members may be required when very heavy objects are being lifted and/or transported and additional support is desired. Similarly, additional pivoting support members may be used.

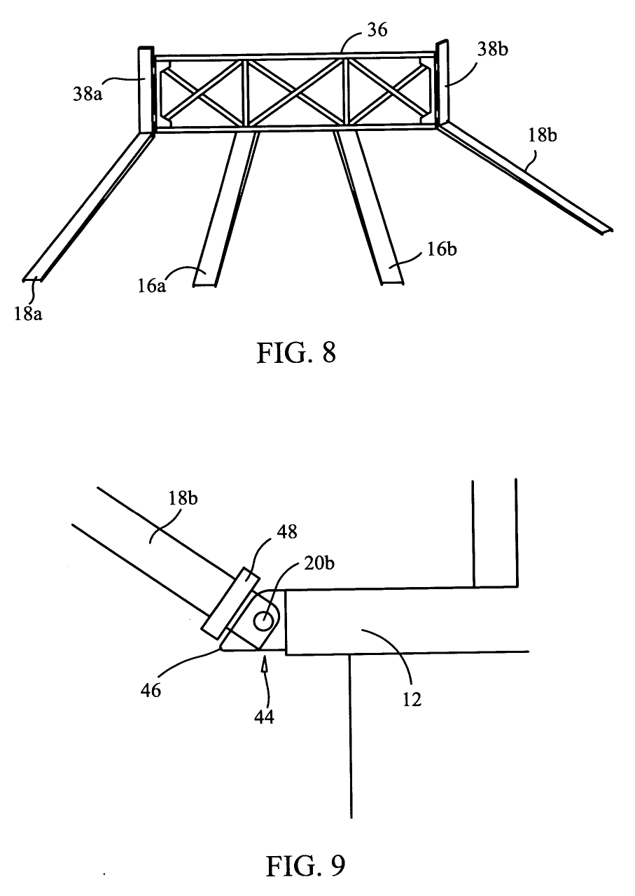

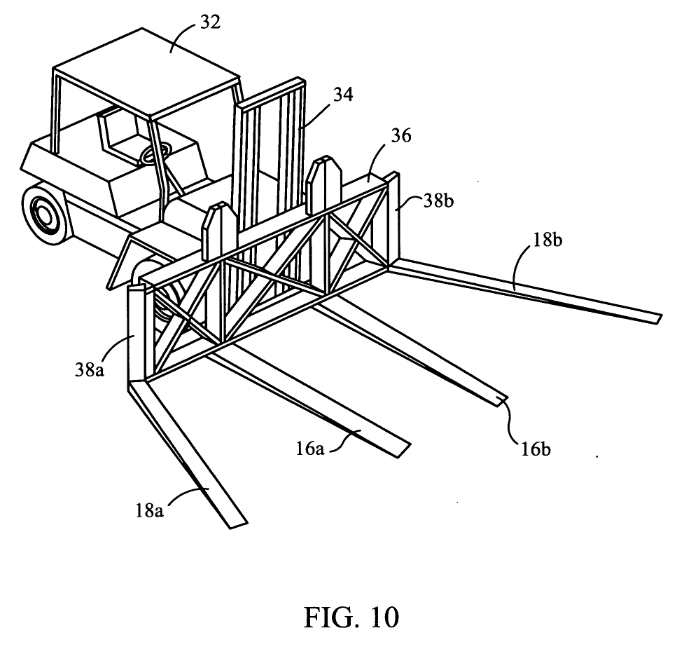

FIG. 8 illustrates an alternate embodiment of the present invention. Here, lift member 36 includes an elongated member, bordered by vertical members 38a and 38b. Extending horizontally from members 38a and 38b are pivoting support members 18a and 18b respectively. Fixed support members 16a and 16b are between outer pivoting members 18a and 18b and extend horizontally from lift member 36. Lift member 36 is connected to lift chassis 34 of forklift 32 (shown in FIG. 10) and can be raised or lowered upon lift member 36 by the forklift operator. The forklift operator positions lift member 36 proximate a large object, maneuvers the support members until they are beneath the object and operates the lift chassis to raise lift member 36 and the object support by the support members. Again, the forklift operator can manipulate the outer pivoting support members 18a and 18b, in essence, expanding the width of the apparatus, in order to support and lift long objects.

FIG. 9 illustrates an alternate embodiment of the invention whereby a stop member 44, advantageously limits the span of pivoting outer support members 18a and 18b. This can be advantageous to a forklift operator who is trying to manipulate attachment 10 under a wide object. Further, stop member 44 acts as a safety mechanism to prevent the inadvertent widening of attachment 10, which may cause the object being supported to slip off the support members.

Stop member 44 is positioned at the point where outer pivoting member 18a and 18b abuts horizontal member 12. Stop member 44 includes angled member 46 which is located at the remote end of horizontal member 12. Angled member 46 abuts stop flange 48, which extends beyond the longitudinal edge of outer support member 18b, as shown in FIG. 9. Hinge 20b allows outer support member 18b to pivot laterally in order to accommodate objects with a large width. However, as outer support member 18b pivots in an outward direction, stop flange 48 is brought into contact with angled member 46 in abutting relation, thus preventing outer support member 18b from pivoting outward any further. Thus, stop member 44 acts as a safety feature by advantageously limiting the pivoting range of outer support members 18a and 18b. By preventing each outer support member 18a and 18b from swinging past a particular point, attachment 10 may be used to lift, support and transfer objects of varying widths and dimensions while limiting the likelihood that the pivoting support members 18a and 18b would splay out too far and the object supported thereon fall between the support members.

FIG. 10 illustrates the alternate embodiment of the attachment 10 shown in FIG. 8. IN this embodiment, lift chassis 34 engages lift member 36. Lift member 36 may be raised or lowered by the forklift operator. Lift member 36 travels up and down with respect to lift chassis 34 after the forklift operator has manipulated the support members under the object to be lifted and/or transported. As described above, outer support members 18a and 18b are pivotable and can support ling objects. Once the forklift 32 has been positioned proximate the object and the support members slid under the object, the forklift operator activates the lift mechanism and lift member 36 is slowly raised along lift chassis 34 and the object, supported by support members 16a, and 16b and 18a and 18b can be transported to the desired destination. It should be noted that fixed support members 16a and 16b support the majority of the objects weight. Pivotable support members 18a and 18b support only a small portion of the object's weight and are advantageously used to accommodate objects of varying sizes and dimensions.

While this version of the invention has been illustrated and described in detail in the drawings and foregoing description, the same is to be considered as illustrative and not restrictive in character, it being understood that only the preferred embodiment has been shown and described and that all changes and modifications that come within the spirit of the version of the invention are desired to be protected. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

From the foregoing, it will be understood by persons skilled in the art that an improved roof truss moving attachment for forklift has been provided. The invention is relatively simple and easy to manufacture, yet affords a variety of uses, While my description contains many specificities, these should not be construed as limitations on the scope of the version of the invention, but rather as an exemplification of the preferred embodiment thereof. The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be resorted to, falling within the scope of the invention.

Although this invention has been described in its preferred form with a certain degree of particularity, it is understood that the present disclosure of the preferred form has been made only by way of example and numerous changes in the details of construction and combination and arrangement of parts may be resorted to without departing front the spirit and scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A forklift attachment comprising:
a horizontal member having hinges on the remote ends thereof;
a plurality of pivotable outer support members in rotational engagement with the hinges and extending laterally therefrom wherein said pivotable outer support members can be pivoted laterally to support objects of varying sizes and dimensions; and
one or more fixed support members mounted on said horizontal member and extending laterally therefrom, said one or more fixed support members adapted to fit over fork members of a forklift and support an object thereon.

2. The forklift attachment of claim 1, further comprising one or more vertical members mounted on said horizontal member and extending upward therefrom.

3. The forklift attachment of claim 3, wherein the two or more vertical members are tubular.

4. The forklift attachment of claim 1, wherein at least one of the support members are tapered with the thickest part proximate the horizontal member.

5. The forklift attachment of claim 1, wherein the pivotable support members each include a stop member that prevents the pivotable support members from pivoting outward beyond a predetermined point.

6. The forklift attachment of claim 5, wherein the stop member comprises:
an angled member extending from an end of the horizontal member proximate the pivotable support member; and
a stop flange disposed proximate an end of the outer pivotable support member adjacent the horizontal member, the stop flange in abutting relationship with the angled member when the pivotable support member swings laterally past the predetermined point.

7. The forklift attachment of claim 1, wherein the fixed support members each comprise:
a top side member;
a bottom side member; and
opposing lateral side members,
wherein the opposing lateral side members extend below the plane of the bottom side member thus forming a channel that receives the fork members of the forklift.

8. The forklift attachment of claim 2, wherein the one or more vertical members are slidably engagable with a lifting mechanism of the forklift.

9. A forklift attachment for a forklift which is capable of transporting roof trusses, the forklift attachment comprising:
a horizontal beam member having hinges with vertical hinge pins on the remote ends thereof;
outer support members pivotably coupled to the hinges wherein said outer support members can be pivoted horizontally to support roof trusses of varying widths and dimensions;
two or more vertical members mounted on said horizontal beam; and
a pair of fixed, substantially horizontal support members mounted on said horizontal beam, said fixed horizontal support members adapted to fit over the fork members of forklift.

10. The forklift attachment of claim 9, wherein the beam member is tubular.

11. The forklift attachment of claim 9, wherein at least one of the support members are tapered with the thickest part proximate said hinges.

12. The forklift attachment of claim 9, wherein the pivotable support members each include a stop member that prevent the pivotable support members from pivoting outward beyond a predetermined point.

13. The forklift attachment of claim 12, wherein the stop member comprises:
an angled member extending from an end of the horizontal member proximate the pivotable support member; and
a stop flange disposed proximate an end of the outer pivotable support member adjacent the horizontal member, the stop flange in abutting relationship with the angled member when the pivotable support member swings laterally past the predetermined point.

14. The forklift attachment of claim 9, wherein the fixed support members each comprise:
a top side member;
a bottom side member; and
opposing lateral side members,
wherein the opposing lateral side members extend below the plane of the bottom side member thus forming a channel that receives the fork members of the forklift.

15. The forklift attachment of claim 9, wherein the vertical members are slidably engagable with a lifting mechanism of the forklift.

16. A method of lifting objects, the method including an attachment for a forklift, the method comprising:
providing a forklift attachment, the attachment including:
a horizontal member having hinges on the remote ends thereof;
one or more fixed support members mounted on said horizontal member and extending laterally therefrom, said one or more fixed support members adapted to fit over fork members of the forklift and support the object thereon; and
a plurality of pivotable outer support members in rotational engagement with the hinges and extending laterally therefrom;
coupling the forklift attachment to the forklift; and
manipulating one or more of the plurality of pivotable support members to support objects of varying sizes and dimensions.

17. The method of claim 16, wherein the forklift attachment further includes one or more vertical members mounted on said horizontal member and extending upward therefrom.

18. The method of claim 16, wherein the pivotable support members each include a stop member that prevents the pivotable support members from pivoting outward beyond a predetermined point.

19. The method of claim 18, wherein the stop member comprises:
an angled member extending from an end of the horizontal member proximate the pivotable support member; and
a stop flange disposed proximate an end of the outer pivotable support member adjacent the horizontal member, the stop flange in abutting relationship with the angled member when the pivotable support member swings laterally past the predetermined point.

20. The method of claim 16, wherein manipulating one or more of the plurality of pivotable support members to support objects of varying sizes and dimensions includes allowing one or more of the pivotable support members to pivot laterally until a proper span has been attained.
